(19) United States
(12) Patent Application Publication
(10) Pub. No.: US 2007/0076760 A1
(43) Pub. Date: Apr. 5, 2007

(54) Method and network for detection of device information of mobile stations

(76) Inventors: Martin Wennberg, Bromma (SE); Britt-Mari Svensson, Sollentuna (SE); Tommy Thorstensson, Bromma (SE)

Correspondence Address: FASTH LAW OFFICES (ROLF FASTH), 26 PINECREST PLAZA, SUITE 2, SOUTHERN PINES, NC, 28387-4301, US

(21) Appl. No.: 10/595,941

(22) PCT Filed: Nov. 12, 2004
(86) PCT No.: PCT/SE04/01633

§ 371 Date: May 20, 2006

(30) Foreign Application Priority Data
Nov. 27, 2003 (SE) 0303210-9

(51) Int. Cl. H04J 3/18

(52) U.S. Cl. 370/477

(57) ABSTRACT

The mobile telecommunication network of the invention is used for detection of device information, such as subscriber information and equipment information, The network has a mobile station with subscriber information, a base station subsystem, and a network subsystem. The network of the invention has detecting device information for signals sent from the mobile station, a detector for handling the detected information, and a repository for storing device information. The method detects device information of a mobile station that attaches to the network. The detected device information is compared with the device information stored in the network and stored if it does not correspond to the information previously stored in the network.

### TECHNICAL FIELD

The invention is concerned with a method and a mobile telecommunication network for detection of device information of mobile stations used.

### BACKGROUND ART

GSM, together with other technologies, is part of an evolution of wireless mobile telecommunication that includes e.g. General Packet Radio System (GPRS), and Universal Mobile Telecommunications Service (UMTS).

The Global System for Mobile Communication (GSM) is a standard for digital wireless communications with different services, such as voice telephony. The Subscriber Identity Module (SIM) inside GSM phones was originally designed as a secure way to connect individual subscribers to the network but is nowadays becoming a standardized and secure application platform for GSM and next generation networks.

UMTS is the next (3^{rd}) generation mobile communication system, which provides an enhanced range of multimedia services, such as video. UMTS has specified the use of the USIM (universal SIM) as the evolution of SIM. In GSM and UMTS networks, the (U)SIM card is central both for subscriber identification and for providing value added services to users. Usually referred to as a SIM card, the USIM (Universal Subscriber Identity Module) is the user subscription to the UMTS mobile network. The USIM contains relevant information that enables access onto the subscribed operator's network.

The functional architecture of a GSM system can be broadly divided into the Mobile Station, the Base Station Subsystem, and the Network Subsystem. The subscriber carries the mobile station, the base station subsystem controls the radio link with the mobile station and the network subsystem performs the switching of calls between the mobile users and other mobile and fixed network users.

The Mobile Station (MS) is the equipment the GSM user sees from the whole system. It actually consists of two distinct entities. The actual hardware is the Mobile Equipment (ME), also refered to as the “terminal” or the “handset”, which consists of the physical equipment, such as the radio transceiver, display and digital signal processors. The subscriber information is stored in the Subscriber Identity Module (SIM), implemented as a Smart Card.

The SIM card is a smart card that saves subscriber information about identity, subscription, subscriber environment, radio environment and other information. The information in the SIM is stored in a logical structure of files.

The mobile equipment is uniquely identified by the International Mobile Equipment Identity (IMEI) being a unique code that corresponds to a specific GSM handset. The SIM card, in turn, is identified by the Integrated Circuit Card Identity (ICCID) determining the serial number of the card, and contains the International Mobile Subscriber Identity (IMSI), identifying the subscriber, a secret key for authentication, and other user information.

The term “device information” comprises in this text both equipment information, such as the IMEI, and SIM information, such as the ICCID or the subscriber identity, i.e. IMSI. The IMEI and the IMSI are, however, independent and can thereby provide personal mobility.

The central component of the network subsystem is the mobile services switching center (MSC). This acts like a normal switching node of the PSTN (Public Switched Telephone Network) or ISDN (Integrated Services Digital Network) and connects the mobile signal to these fixed networks. It additionally provides all the functionality needed to handle a mobile subscriber. The Mobile Station Integrated Service Digital Network Number, MSISDN, is the standard international telephone number used to identify a given subscriber.

The Short Message Service Center (SMSC) enables subscribers to send and receive messages in the Cellular network. It can be interfaced with Mobile Switching centers (MSCs) over an SS7 link. The entities, which may receive or send short messages may be located in a fixed network, a mobile station, or another service center. The Short Message Service Center (SMSC) is responsible for the relaying, storing and forwarding of a short message between such an entity and a mobile station.

The operator declares the subscription in a database inside the network, which holds the correspondence between the IMSI and the MSISDN. By inserting the SIM card into another GSM station, the user is able to receive and make calls from that terminal, and receive other subscribed services.

When a new (U)SIM is issued, a lot of information, both personal and to some extent operator defined, is lost, unless this information is copied from the old (U)SIM to the new (U)SIM. This could for example be the phone book.

Introducing a new terminal has other problems—since it is not personalized as (U)SIM cards are. Hence it is required to be configured with network settings to be enabled to use the different services the Mobile Service Provider offers. Apart from that, the same problem with personal information and services, as with the (U)SIM Cards, applies.

Today it is not possible to know what handset model a user is using, if not explicitly notified by the user. This is especially a problem when trying to keep a repository up to date with active handsets, potentially to be used for updating the handset with appropriate data.

### OBJECT OF THE INVENTION

The object of the invention is to develop a solution for better management of subscriber and equipment information, especially in situations wherein subscriber information changes.

### SUMMARY OF THE INVENTION

The method of the invention is performed in a mobile telecommunication network for detection of device information including subscriber information and equipment information. The network comprises a mobile station with a terminal part and with a module for subscriber information and an application, and a repository for storing device information. In the method, the application in the mobile station detects device information of a mobile station attaching to the network, compares the detected device information to the device information previously stored in the mobile station, and sends the detected device information to be stored in the network repository if it does not correspond to the information previously stored.

The mobile telecommunication network of the invention further comprises a detector for handling device information. The mobile station of the invention included in this network has an application and detects device information.

The preferable embodiments of the invention have the characteristics of the subclaims.

The invention thus provides terminal based methods for detecting what devices (mobile station, i.e. handset and/or SIM) a mobile user is using, and means for provisioning them with relevant information.

The invention is especially topical in a situation, wherein the subscriber either has changed his mobile terminal (by inserting the old SIM in the new terminal) or changed the SIM card (by removing the old SIM card from the terminal and inserted a new one). In this text, the term “Terminal Switch” is used for the former case and the term “SIM switch” for the latter case.

The method of the invention is primarily implemented in the GSM or UMTS network, whereby the subscriber information, such as information about identity, subscription, subscriber environment, radio environment, etc. described by the IMSI, is stored in

The Subscriber Identity Module (SIM) inside GSM phones and the Universal SIM (USIM) when implemented in the UMTS network.

The solution of the invention has two major steps, i.e. the detection of a new device (SIM or terminal) being used by a user and updating the new device with relevant data. This solution is based on an application executing on a Smart Card, such as the SIM card. The detection of the new device is sent to a central system (Device Switch Detector, which either can be a Terminal Switch Detector TSD or a SIM Switch Detector (SSD) to act on this information. The solution could for example be implemented as a combination of Wireless Internet Browser applications (WlBlet(s)) and a plug-in, for WIB enabled cards or as a Java Card Applet for Java Cards or as a SIM application toolkit.

The detection of the device information is performed by sending this information from the mobile subscriber terminal to an application in the mobile station, as a consequence of which the application performs said detection.

The detection of a new terminal (Terminal Switch) is based on the terminal identity (IMEI) being stored on the SIM Card. When the SIM Card is initialized the IMEI from the previous initialization is compared with the current IMEI, requested by the application from the handset. If they differ—it is an indication of that a terminal switch has taken place and this information is sent to the TSD server for further processing.

The detection of a new SIM card (SIM Switch) could be detected by using the same mechanism as above (comparing IMEI), or a dedicated mechanism (comparing a dedicated SIM Switch parameter). When the SIM card is initialized, the application reads the IMEI (or the dedicated SIM Switch parameter) from its stored position, which is on the SIM card. If it is found to be 0 (or not defined), it indicates that the SIM is being used for the first time. The unique SIM identity (e.g. ICCID) is sent to the SIM Switch Detector to evaluate the given information and make the decision whether it was a SIM Switch or not. The decision is based on comparing the given SIM identity read from the SIM card with the information previously stored in the SIM repository in the network.

The advantages of the invention are that automatic provisioning is possible on terminal switch, which solves the problems faced in the background art section. The solution to all the non-configured handsets is to automatically provision them with accurate configuration data when a handset is being used for the first time.

Moreover, personal settings from an old handset can be restored. When a user has started to use a new handset it could be updated with personal information, in addition to the network configuration data. Personal information that was on the old handset, and stored in the network, could be downloaded to the handset, upon user acknowledgement. Personal information could for example be WAP bookmarks, Java applets, logos, ringtones etc.

A detection of a handset switch will lead to that the system downloads the personal settings used in the old handset, previously stored in the system. Applications could also be downloaded and the system could even download the same applications potentially upgraded to suit the capabilities of the new handset, e.g. a game designed for a small screen used on the old handset could be replaced with the same game designed for a larger color screen—according to the capability of the new handset.

When a new SIM has been introduced it could be updated with information from an image of the old SIM card. Operator defined data, if not pre-personalized, could automatically be downloaded. Personal data if stored/backed-up in the operator's domain, e.g. the Phonebook, could be downloaded, preferably after a question been sent to the user (by e.g. Text SM, WIG push, or WAP push) and acknowledged by the same (via e.g. Text SM, WIG message, or WAP message).

In the following, the invention will be described by means of some embodiments of the invention by referring to figures. The invention is not restricted to the details of the description.

### FIGURES

FIG. 1 shows an environmental view of a network of the invention, wherein an embodiment of the method of the invention can be implemented.

FIG. 2 presents a flow scheme of an embodiment of the method of the invention implemented in the network of FIG. 1

FIG. 3 presents a flow scheme of an other embodiment of the method of the invention implemented in the network of FIG. 1

### DETAILED DESCRIPTION

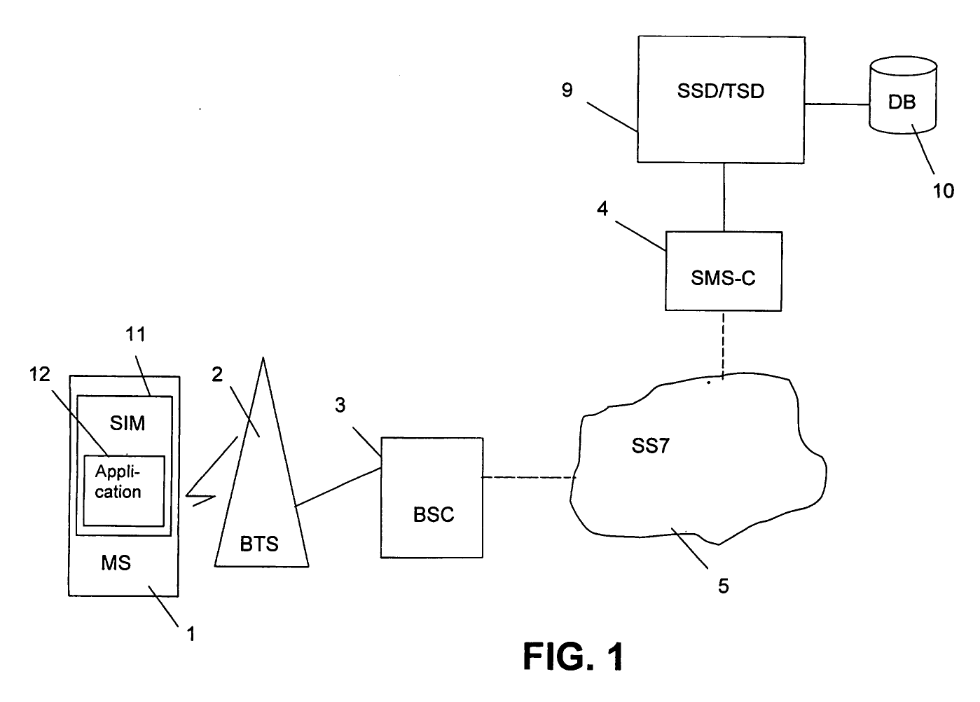

FIG. 1 is an architectural view of the network structure, in which the method of the invention can be implemented. In FIG. 1, it is assumed that the invention is implemented in the GSM network.

The GSM network has different parts. The Mobile Station (MS) with reference number 1 is carried by the subscriber. The Base Station Subsystem (BSS) controls the radio link with the Mobile Station. A cell is formed by the coverage area of a Base Transceiver Station (BTS) having reference number 2 in FIG. 1; which serves the MS 1 in its coverage area. Several BTS stations together are controlled by one Base Station Controller (BSC) having reference number 3 in the figure. The BTS 2 and BSC 3 together form the Base Station Subsystem (BSS). The Mobile Station and the Base Station Subsystem communicate across the air interface through a radio link.

The Network Subsystem, the main part of which is the Mobile services Switching Center (MSC) (not shown) performs the switching of calls between the mobile and other fixed or mobile network users, as well as management of mobile services, such as authentication. The Operations and Maintenance center (not shown) oversees the proper operation and setup of the network.

The communication from BSC 3 further is based on signaling system no. 7 (SS7) protocol, which is indicated with reference number 5 in the figure and constitutes the wireless network signaling infrastructure in GSM. SS7 is a global standard for telecommunications defined by the International Telecommunication Union (ITU) Telecommunication Standardization Sector (ITU-T). The SS7 standard defines the procedures and protocol by which the network elements exchange information over a digital signaling network to effect secure worldwide telecommunications.

The Short Message Service Center (SMSC) with reference number 4 in FIG. 1 enables subscribers to send and receive messages and is interfaced with the Mobile Switching centers (MSCs) over an SS7 link.

All the above functions are parts of the GSM standard. When implemented in GSM, the invention introduces some further functions in the network.

Inventive functions in FIG. 1 is a Device Switch Detector 9 that can be a Terminal Switch Detector (TSD) or a SIM Switch Detector (SSD) depending on which embodiment of the invention it is question about. When the Device Switch Detector 9 is a TSD, a repository 10 that contains lists of pairs of IMEI/IMSI, IMEI/MSISDN or IMEI/IMSI/MSISDN values is connected to it. When the Device Switch Detector 9 is an SSD, a repository 10 that contains lists of pairs of IMSI/MSISDN/ICCID values is connected to it.

A further inventive function in FIG. 1 is an application 12 on the SIM card executed by a signal from the SIM operating system that the terminal has been switched on.

In a first embodiment, the application program is a Terminal Switch Application, which asks the telephone of the IMEI and reads the IMEI from a memory space on SIM. All data on the SIM are stored in files and one of those is available for the application. Thereafter, the application 12 evaluates whether there is a new terminal, i.e. if the read IMEI and the previously stored IMEI differ from eachother. If so, this information is sent to a Terminal Switch Detector (TSD) 9, which interprets the signal by means of a repository 10 containing lists of pairs of IMEI/IMSI values or IMEI/MSISDN values and connected to the TSD 9.

When TSD gets the information that a subscriber has changed telephone (the IMEI/IMSI or IMEI/MSISDN pair updated with a new IMEI), TSD then updates the repository information and also the IMEI information in the SIM file by e.g. sending a SMS message to SIM and preferably sending a signal to those components, that are interested in knowing that a subscriber has changed telephone (a terminal switch has taken place). This change is interesting because it is now known that an unconfigured telephone exists and that suitable things can be sent to the telephone to have it work with Global Packet Radio Services (GPRS), Wireless Application Protocol (WAP), e-mail etc.

In another embodiment of the invention, the application program is a SIM Switch Application, which reads an indicator from a memory space on the SIM in order to evaluate whether there is a new SIM. If so, this information is sent to a SIM Switch Detector (SSD) 9, which interprets the signal by means of the repository 10. In this embodiment, the repository contains lists of MSISDN/IMSI/ICCID values and is connected to the SSD 9. When SSD gets the information that a subscriber has changed SIM, it updates the information in the MSISDN/IMSI/ICCID repository and sends back an acknowledgement to the SIM Switch Application to store a value for the SIM Switch indicator that a SIM Switch has taken place.

The TSD or SSD is connected to the SMSC 4 in FIG. 1, which enables it to send and receive information about IMEI/MSISDN/IMSI/ICCID values in form of SMS messages to and from the SIM 11.

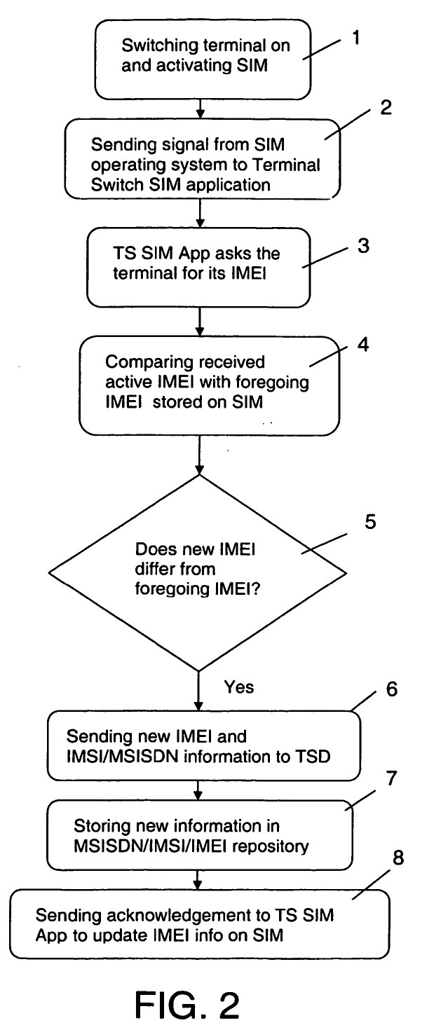

FIG. 2 presents a flow scheme of an embodiment of the method of the invention used when a mobile station attaches to the network, here a network according to FIG. 1. It is assumed that the user of the mobile terminal has changed his mobile terminal but kept his old SIM card by transferring it to the new terminal.

When the terminal is switched on (step 1 of FIG. 2), a signal is sent (in step 2 of FIG. 2) from the SIM operating system to the Terminal Switch SIM application in order to start said application.

The application starts with asking, in step 3 of FIG. 2, the terminal for its International Mobile Equipment Identity (IMEI), i.e. the unique code that corresponds to a specific GSM terminal.

When the terminal has given the requested IMEI information to the application, the Terminal Switch SIM application compares in step 4 of FIG. 2 the given IMEI information with the IMEI value read from the SIM file showing what terminal the SIM was in the last time it was restarted. If it in step 5 of FIG. 2 is found that the new IMEI differs from the previously stored IMEI, a terminal switch is considered to have happened.

Information about the subscriber, either the International Mobile Subscriber Identity (IMSI) or the standard International telephone number used to identify a given subscriber (MSISDN) or both as well as the new IMEI is thereafter sent in step 6 of FIG. 2 to the Terminal Switch Detector (TSD) with an SMS message. The TSD then stores the new information in the IMSI/IMEI, IMSI/MSISDN/IMEI or MSISDN/IMEI repository in step 7 of FIG. 2 and sends acknowledgement to the Terminal Switch SIM application to update IMEI information on SIM in step 8 of FIG. 2.

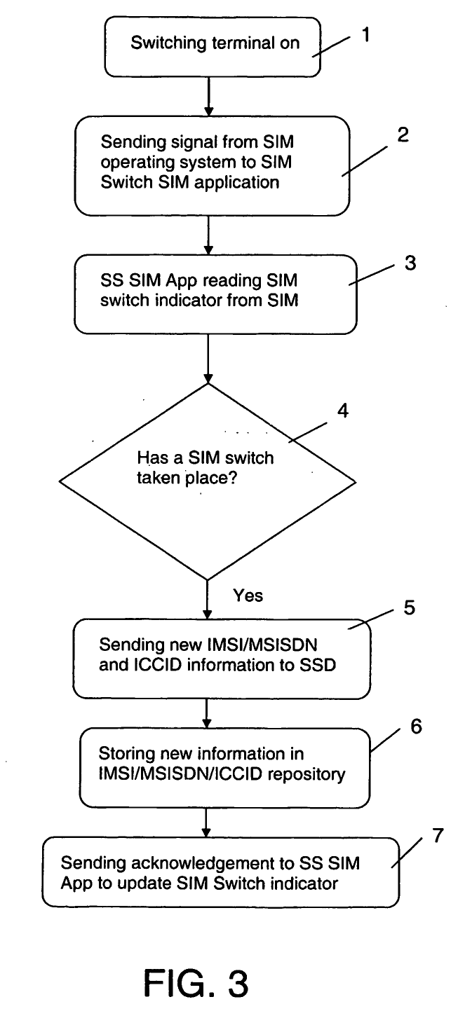

FIG. 3 presents a flow scheme of an other embodiment of the method of the invention used when a mobile terminal attaches to a network according to FIG. 1.

Now it is assumed that the user of the mobile terminal has changed his SIM card by removing the old SIM card and inserting a new one into the terminal (old or new).

When the terminal is switched on (step 1 of FIG. 3), a signal is sent (in step 2 of FIG. 3) from the SIM operating system to the SIM Switch SIM application in order to start said application.

The application starts with step 3 of FIG. 3, wherein the SIM Switch Application reads the value of a SIM Switch Indicator. This indicator is a variable on the SIM card being e.g. “0” or undefined until a SIM Switch is reported, and e.g. “1” after a SIM Switch has been reported.

If the SIM Switch Application notes in step 4 of FIG. 3 on the basis of the SIM Switch indicator that a SIM Switch has taken place, it sends new IMSI/MSISDN and ICCID information to the SIM Switch Detector (SSD) in step 5 of FIG. 3. In step 6 of FIG. 3, the new information is stored in the IMSI/MSISDN/ICCID repository, whereafter an acknowledgement is sent in step 7 of FIG. 3 to the SIM Switch Application to update the SIM Switch indicator to e.g. “1”.

When the user again changes to a new SIM card, the SIM Switch indicator on the new SIM card has the value “0”, which is read by the SIM Switch application when the terminal is switched on. The SIM Switch Application then again performs steps 4-5 and stores the new indicator value “1” when an aknowledgement has come from the SSD that the new information has been stored in the IMSI/MSISDN/ICCID repository.

1. Method in a mobile telecommunication network for detection of device information including subscriber information and equipment information, the network comprising a mobile station with a terminal part and with a module for subscriber information and an application, the network further comprising a repository for storing device information, the method comprising:
a) the application of the mobile station detecting device information of a mobile station attaching to the network,
b) the application of the mobile station comparing the detected device information to the device information previously stored in the mobile station, and
c) the application of the mobile station sending the detected device information to be stored in the network repository if it does not correspond to the information previously stored.

2. Method of claim 1, wherein the application is situated in the module for subscriber information and is executed by a signal from the operation system of the module for subscriber system when the mobile terminal is switched on.

3. Method of claims 1 wherein when detecting equipment information, the application reads the previously stored device information from a memory space in the mobile station from the module with subscriber information and the application requests the detected device information from the terminal of the mobile station, the detected information being compared to the previously stored device information.

4. Method of claim 1 wherein when detecting equipment information, the detected device information is compared to the device information previously stored in the mobile station by means of an indicator, which is read by the application from a memory space in the mobile station, the value of the indicator indicating whether a switch of the module with subscriber information has taken place.

5. Method of claim 1 wherein when the network is based on GSM or UMTS, the module with subscriber information is the Subscriber Identity Module (SIM) or the Universal Subscriber Identity Module (USIM), respectively.

6. Method of claim 3, wherein when detecting equipment information, a terminal switch is detected and the application is a Terminal Switch Application (TSD) in the Subscriber Identity Module (SIM) of the mobile station.

7. Method of claim 6, wherein the device information detected by said terminal switch application consists of equipment information, such as the International Mobile Equipment (IMET) number.

8. Method of claim 5 wherein the repository stores lists of pairs of International Mobile Equipment (IMEI) numbers and either or both of International Mobile Subscriber Identity (IMSI) numbers and Mobile Station Integrated Service Digital Network (MSITSN) numbers.

9. Method of claims wherein when the IMEI value detected does not correspond to the IMEI previously stored on the SIM card it is updated to the SIM card and sent to be stored in said repository storing pairs of IMEI/IMSI and or MSISDN values.

10. Method of claim 4, wherein when detecting subscriber information, a SIM switch is detected and the application is a SIM Switch Application in the Subscriber Identity Module (SIM) of the mobile station.

11. Method of claim 5 wherein the repository stores lists of pairs of International Mobile Subscriber Identity (IMSI) numbers, Mobile Station Integrated Service Digital Network (MSISDN) numbers and Integrated Circuit Card ID (ICCID) numbers.

12. Method of claims 10 wherein the device information detected by said SIM switch application is an indicator value indicating whether a SIM switch has taken place.

13. Method of claim 12, wherein when according to said indicator value, a SIM switch has taken place, subscriber information, such as new IMSI/MSISDN/ICCID values, are sent to be stored in said repository storing pairs of IMSI/MSISDN/ICCID values and said indicator value is updated to tell about the SIM switch.

14. Mobile telecommunication network for detection of device information comprising: the device information having subscriber information and equipment information, the network having a mobile station with a terminal part and with a module for subscriber information and an application, the network having a repository for storing of device information, the mobile station having an application for detecting device information, the network further having a detector for handling device information, and a repository for storing device information.

15. Mobile telecommunication network of claim 14 wherein the network is based on GSM or UMTS, the module with subscriber information being the Subscriber Identity Module (SIM) or the Universal Subscriber Identity Module (USIM), respectively.

16. Mobile telecommunication network of claim 14 wherein the application for detecting device information consists of a device switch application in the Subscriber Identity Module (SIM) of the mobile station.

17. Mobile telecommunication network of claim 16, wherein the device switch application in the Subscriber Identity Module (SIM) of the mobile station is a Terminal Switch Application.

18. Mobile telecommunication network of claim 17, wherein the repository stores lists of pairs of International Mobile Equipment (IMPI) numbers and any or both of International Mobile Subscriber Identity (IMSI) numbers and MSISDN values.

19. Mobile telecommunication network of claim 14 wherein the detector for handling device information is a Terminal Switch Detector (TSD).

20. Mobile telecommunication network of claim 16, wherein the device switch application in the Subscriber Identity Module (SIM) of the mobile terminal is a SIM Switch Application.

21. Mobile telecommunication network of claim 17, wherein the repository stores lists of International Mobile Subscriber Identity (IMSI) numbers, Mobile Station Integrated Service Digital Network (MSISDN) numbers and Integrated Circuit Card ID (ICCID) numbers.

22. Mobile telecommunication network of claim 20 wherein the Subscriber Identity Module (SIM) contains a variable indicating whether the new IMSI/NSISDN/ICCID information has been stored in the repository.

23. Mobile telecommunication network of claim 20 wherein the detector for handling device information is a SIM Switch Detector (SSD).

24. (canceled)

25. (canceled)

26. (canceled)

27. (canceled)
